(19) United States
(12) Patent Application Publication
(10) Pub. No.: US 2007/0053143 A1
(43) Pub. Date: Mar. 8, 2007

(54) Electrical device with vents

(75) Inventor: Lun-Wei Kang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/495,512

(22) Filed: Jul. 31, 2006

(30) Foreign Application Priority Data
Sep. 6, 2005 (TW) 94130601

(51) Int. Cl. H02B 1/56

(52) U.S. Cl. 361/678

(57) ABSTRACT

An electrical device with vents is provided. The electrical device comprises a case, a sliding part, a spring, and an electromagnetic coil. The case comprises a first vent and a sliding assembly. The sliding assembly is installed at one side or both sides of the first vent, and the sliding part is movable along the sliding assembly. The spring and the electromagnetic coil are separately on each side of the sliding part. When this electrical device detects that heat should be removed, the electromagnetic coil is powered for generating magnetic force to stretch the spring and move the sliding part to the first position to open the first vents. When the electromagnetic coil is not powered, the spring pulls the sliding part back to the second position to close the first vent.

### RELATED APPLICATIONS

The present application is based on, and claims priority from, Taiwan Application Serial Number 94130601, filed Sep. 6, 2005, the disclosure of which is hereby incorporated by reference herein in its entirety.

### BACKGROUND

1. Field of Invention

The present invention relates to an electrical device with vents, and especially relates to an electrical device that can open and close the vents by setting conditions automatically.

2. Description of Related Art

As information technologies and the computer industry develop abundantly, portable devices, such as notebook computers, are becoming sleeker and better miniaturized to keep with modern fashion trends.

These delicate portable devices of high efficiency and small size are plagued by high temperature chips and heat emission inefficacy, which can induce the device functions to fail. Therefore, the design of heat emission mechanisms becomes an important topic.

Nowadays, heat emission mechanisms of electrical devices generally comprise openings in the device cases. However, dust intrudes the devices through these openings and can make the device functions fail. The traditional solution of this problem is to install a mask with holes to prevent the intrusive dust, but this solution reduces the efficiency of heat emission. Therefore, an electrical device with vents is needed, which prevents dust while maintaining heat emission efficiency.

### SUMMARY

It is an objective of the present invention to provide an electrical device with vents, wherein the electrical device can open or close a first vent by controlling a sliding part.

It is another objective of the present invention to provide an electrical device with vents that prevents dust while maintaining heat emission efficiency.

In accordance with the foregoing objectives, the present invention offers a sliding part for a traditional electrical device. When the electrical device is powered off or the electrical device is powered on but has not reached a certain high temperature, the sliding part is at a second position to close the heat emission openings. Thus, the sliding part can prevent the intruding dust that damages the circuitry inside the device case. When the electrical device is powered on and reaches a certain high temperature to emit heat, the sliding part is moved by a pulling mechanism to a first position to open the heat emission openings. Thus, the openings can allow the heat to emit outward. When the temperature inside the case declines or the device is powered off, the sliding part is moved back to the second position by a returning mechanism to close the heat emission openings again.

An embodiment of this invention provides an electrical device with vents. The electrical device comprises a case, a sliding assembly, a sliding part, a pulling mechanism, and a returning mechanism. The pulling mechanism of this embodiment is an electromagnetic coil, and the returning mechanism of this embodiment is a spring. There are at least one first vent and a sliding assembly on the case, and the sliding assembly is located at one side of the first vent. The sliding part is located at the sliding assembly, and the sliding part slides between the first position and the second position. The electromagnetic coil and the spring are located at each side of the sliding part. When the electrical device detects the condition of heat emission, the electromagnetic coil is electrified to generate magnetic force for pulling the sliding part to the first position to open the heat emission openings; the spring is stretched at this moment. When the electromagnetic coil is not electrified, the sliding part is returned back to the second position by the spring to close the heat emission openings.

In the embodiment of this invention, there are at least one second vent and at least one covering part on the sliding part. When the sliding part is at the first position, the second vent aligns with the first vent to open the heat emission openings. When the sliding part is at the second position, the covering part aligns with the first vent to close the heat emission openings.

By the application of the controllable sliding part of this invention to open and close the heat emission openings, dust intrusion is prevented and heat emission efficiency is maintained. When the electrical device does not reach the heat emission condition, the sliding part closes the heat emission openings to prevent the intruding dust. When the electrical device reaches the heat emission condition, the sliding part is moved to open the heat emission openings to allow the heat to escape. When the temperature of the electrical device declines, the sliding part is moved back to close the heat emission openings again. This invention can prevent the problems associated with the always-open heat emission openings of traditional designs while maintaining the desired heat emission functionality.

### BRIEF DESCRIPTION OF THE DRAWINGS

The invention can be more fully understood by reading the following detailed description of the preferred embodiment with reference made to the accompanying drawings as follows:

FIG. 1 is an inner side view of the case according to one preferred embodiment of this invention;

FIG. 2 is another inner side view of the case according to one preferred embodiment of this invention; and

FIG. 3 is a perspective drawing according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

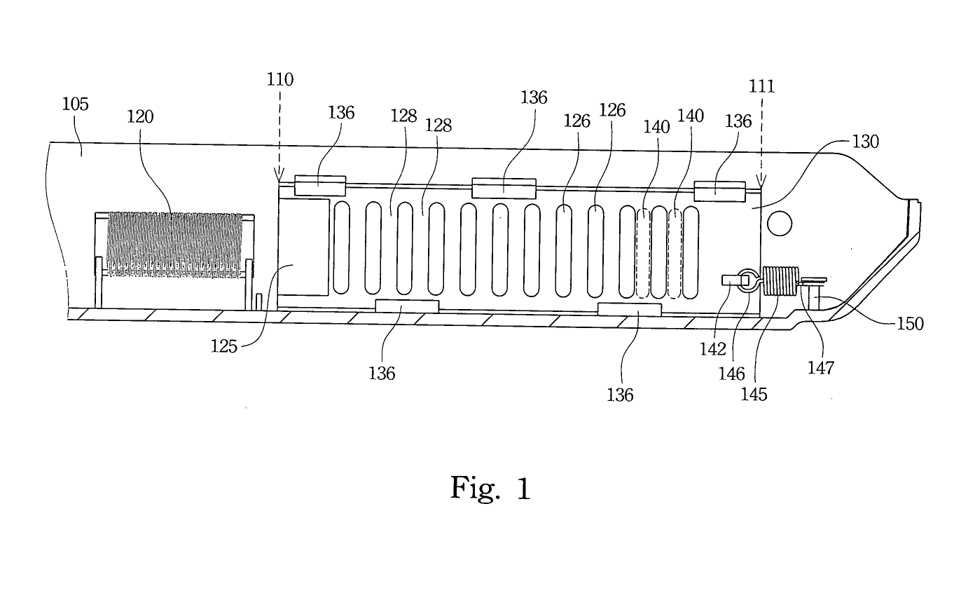

FIG. 1 is an inner side view of the case according to one preferred embodiment of this invention. There are at least one first vent 140 and a sliding assembly 136 on the case 105. The heat emission openings are constructed from first vents 140. The dotted line indicates that the heat emission openings are closed. The sliding part 130 can slide between a first position and a second position along the sliding assembly 136. When the sliding part 130 is at the first position, the first vent 140 is opened. When the sliding part 130 is at the second position, the first vent 140 is closed. An electromagnetic coil 120 is located at the left side of a first side 110 of the sliding part 130, and there is a fixed part 142 on a second side 111 of the sliding part 130. The fixed part 142 is used to connect a first end 146 of a spring 145; and a second end 147 of the spring 145 is used to connect with a bolt 150 of the case 105.

In this embodiment, the sliding assembly 136 comprises a plurality of notches or slides on the topside and the bottom side of the first vent 140, wherein the notches construct a track for the sliding part 130. In other embodiments of this invention, the sliding assembly 136 can be constructed from a long notch at one side of the first vent 140 to construct a track for the sliding part 130. In FIG. 1, the spring 145 connects with the sliding part 130 by the connection between the fixed part 142 and the bolt 150, and the spring 145 can connect with the sliding part 130 by screws (not shown).

Still referring to FIG. 1, the sliding part 130 is a plank structure with a plurality of second vents 126 and a plurality of covering parts 128. The second vent 126 is holed structure. In this embodiment, the sliding part 130 is at the second position, and the covering parts 128 of sliding part 130 overlap the first vent 140 of the case 105 to make the first vent 140 closed. Furthermore, there is a magnetic object 125 at a first side 110 of the sliding part 130. The electromagnetic coil 120 can generate the magnetic force to pull the magnetic object 125 for moving the sliding part 130 to open the heat emission openings (i.e., the first vent 140). Alternatively, the sliding part 130 can be made from a magnetic metal such that this device does not require the magnetic object 125.

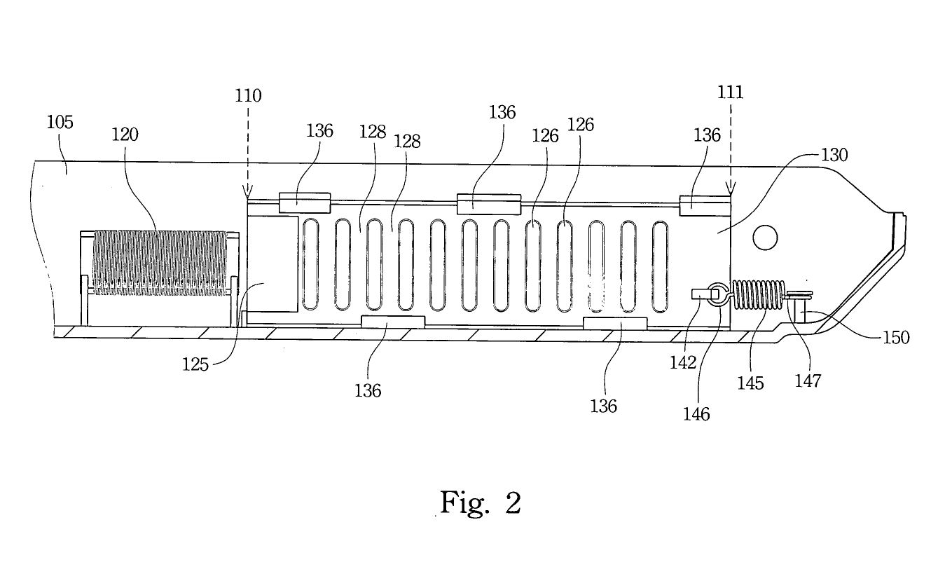

FIG. 2 is another inner side view of the case according to one preferred embodiment of this invention, whereinFIG. 2 differs from FIG. 1 in that the first vent 140 is open. When the electrical device reaches a heat emission condition, a switch (not shown) is activated to make the electromagnetic coil 120 electrified to generate a magnetic force greater than the force of spring 145. The magnetic force pulls the magnetic object 125 (i.e., the sliding part 130, a magnet or a magnetic metal) toward the electromagnetic coil 120 to the first position and makes the second vent 126 align with the first vent 140. Thus, the heat emission openings open and the fan (not shown) pushes the heat outward. Meanwhile, the spring 145 is stretched.

When the temperature of the electrical device declines, the switch (not shown) is deactivated to make the electromagnetic coil 120 unelectrified. The force of the stretched spring 145 returns the sliding part 130 to the second position. Therefore, the heat emission openings are closed and prevent dust and foreign matter from intruding into the case.

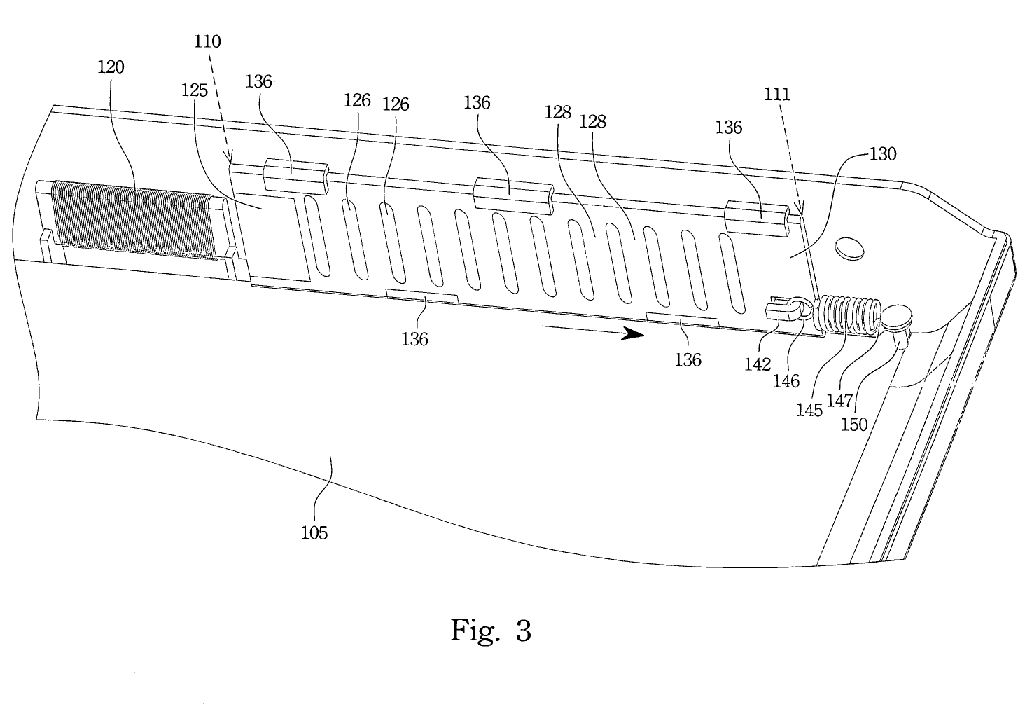

FIG. 3 is a perspective drawing according to one preferred embodiment of this invention.

In other embodiments, a magnet or an electromagnetic coil can replace the spring 145 so long as the force generated by the spring 145 or the magnet is smaller than the force generated by the electromagnetic coil 120.

Although the present invention has been described in detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrical device with vents, the electrical device comprising:
a case with at least one first vent;
a sliding assembly located at one side of the first vent;
a sliding part located in the sliding assembly, and the sliding part slides between a first position and a second position;
a pulling mechanism located at a first side along the moving direction of the sliding assembly, and the pulling mechanism is used to pull the sliding part to the first position; and
a returning mechanism located at a second side along the moving direction of the sliding assembly, and the returning mechanism is used to pull the sliding part to the second position,
when the electrical device has to exhaust heat, the pulling mechanism opens the first vent, and when the electrical device does not have to exhaust heat, the returning mechanism closes the first vent.

2. The electrical device with vents of claim 1, wherein the sliding part comprises at least one second vent and at least one covering part, and the second vent is a hole.

3. The electrical device with vents of claim 2, when the sliding part is at the first position, the second vent aligns with the first vent, and when the sliding part is at the second position, the covering part aligns with the first vent.

4. The electrical device with vents of claim 1, wherein the returning mechanism is a spring.

5. The electrical device with vents of claim 4, further comprising a fixed part at the second side of the sliding part, and a first end of the spring connects with the fixed part.

6. The electrical device with vents of claim 5, further comprising a bolt on the case, and a second end of the spring is fixed on the bolt.

7. The electrical device with vents of claim 1, wherein the pulling mechanism is an electromagnetic coil.

8. The electrical device with vents of claim 1, further comprising a magnetic object at the first side of the sliding part.

9. The electrical device with vents of claim 8, wherein the magnetic object is a magnet.

10. The electrical device with vents of claim 8, wherein the magnetic object is a magnetic metal.

11. The electrical device with vents of claim 1, further comprising a plurality of notches on the sliding assembly, and the notches construct a track for the sliding part.

12. The electrical device with vents of claim 1, wherein the sliding part is a plank.
